(19) United States
(12) Patent Application Publication
(10) Pub. No.: US 2006/0004904 A1
(43) Pub. Date: Jan. 5, 2006

(54) Method, system, and program for managing transmit throughput for a network controller

(75) Inventors: Parthasarathy Sarangam, Portland, OR (US); Sujoy Sen, Portland, OR (US); Anil Vasudevan, Portland, OR (US)

Correspondence Address: KONRAD RAYNES & VICTOR, LLP, Suite 210, 315 S. Beverly Drive, Beverly Hills, CA, 90212, US

(73) Assignee: Intel Corporation

(21) Appl. No.: 10/882,540

(22) Filed: Jun. 30, 2004

(51) Int. Cl. G06F 15/16

(52) U.S. Cl. 709/200

(57) ABSTRACT

Provided are a method, system, and program for managing transmit throughput for a network controller. In one embodiment, transmit requests from an application may be posted by the device driver to the network controller of the network adapter in a pipeline of transmit requests without waiting for an acknowledgment of the transfer of the accompanying transmit data to the network controller. In another aspect, a device driver monitors the available buffer space of a network controller buffer to ensure that the network controller has sufficient available buffer space before posting the next transmit request to the network controller. In accordance with yet another aspect, the device driver can copy transmit data from an application buffer to a driver buffer if the size of the transmit data of a particular transmit request is below a programmable threshold. If so, the device driver can notify the application to permit the application buffer to be released.

### BACKGROUND

### DESCRIPTION OF RELATED ART

In a network environment, a network adapter such as an Ethernet controller, Fibre Channel controller, etc., will receive Input/Output (I/O) requests initiated by an application operating in the host computer in which the adapter resides. Often, the host computer operating system includes a device driver to communicate with the network adapter hardware to manage I/O requests to transmit data over a network. FIG. 1 shows an example of an application 10 of a host computer communicating to a network adapter 12 through a device driver 14. Data to be transmitted by the network adapter is often stored by the application 10 in a buffer 20 which typically resides in system memory of the host computer.

The host computer may also implement a protocol which packages the data to be transmitted over the network into packets, each of which contains a destination address as well as a portion of the data to be transmitted. A protocol layer can also process the packets received by the network adapter that are stored in the packet buffer, and access any I/O commands or data embedded in the packet.

For instance, the computer may implement the TCP/IP (Transmission Control Protocol and Internet Protocol) to encode and address data for transmission, and to decode and access the payload data in the TCP/IP packets received at the network adapter. IP specifies the format of packets, also called datagrams, and the addressing scheme. TCP is a higher level protocol which establishes a connection between a destination and a source. The computer may also utilize the User Datagram Protocol (UDP) to transmit and receive data over a network.

Details on the TCP protocol are described in “Internet Engineering Task Force (IETF) Request for Comments (RFC) 793,” published September 1981 and details on the IP protocol are described in “Internet Engineering Task Force Request for Comments (RFC) 791, published September 1981. Details on the Fibre Channel architecture are described in the technology specification “Fibre Channel Framing and Signaling Interface”, document no. ISO/IEC AWI 14165-25. Details on the Ethernet protocol are described in “IEEE std. 802.3,” published Mar. 8, 2002. Details on the UDP protocol are described in “Internet Engineering Task Force Request for Comments (RFC) 798, published August, 1980.

The packets containing the payload data and address information may be stored in an application buffer 20 prior to being forwarded to a buffer 22 of the network adapter 12 for transmission through the network. In some known systems, packets may also be stored in an intermediate buffer 24 maintained by the device driver 14 in system memory, prior to being forwarded to the buffer 22 of the network adapter 12.

A device driver, application or operating system can utilize significant host processor resources to handle network transmission requests to the network adapter. One technique to reduce the load on the host processor is the use of a TCP/IP Offload Engine (TOE) in which TCP/IP protocol related operations are performed in the network adapter hardware as opposed to the device driver or other host software, thereby saving the host processor from having to perform some or all of the TCP/IP protocol related operations.

FIG. 2 illustrates an example of a prior art data transmission operation in which a device driver 14 receives (block 30) a transmit request from an application 10 wherein the transmit request is a request for transmitting data stored in the application buffer 20, over the network. The device driver 14 forwards (block 32) the transmit request to the network adapter 12 which includes a TOE. In this known example, the device driver 14 awaits (block 34) an acknowledgment from the network adapter 12 that the data to be transmitted pursuant to the transmit request has been successfully transferred to the adapter buffer 22, before the device driver 14 receives (block 30) and forwards (block 32) another transmit request from the same application 10 of the host computer to the network adapter 12. Once the acknowledgment is received, the device driver 14 can inform the application 10 of the successful copying of the data from the application buffer 20 to the network adapter buffer 22. The buffer 20 may then be released and used for other purposes.

FIG. 3 illustrates an example of a prior art data transmission operation in which the network adapter 12 awaits (block 40) receipt of a transmit request from the device driver 14. Upon receipt of the request, the TOE controller of the network adapter 12 transfers (block 42) transmit data, typically in a DMA (Direct Memory Access) operation, from the application buffer 20 to the network adapter buffer 22, to encode the transmit data into packets for transmission over the network. Upon completion of the data transfer, an acknowledgment may be sent (block 44) to the device driver 14, acknowledging transfer of the data to the network adapter 12. In some known systems, the network adapter 12 can also forward to the device driver 14, data indicating the unused buffer space of the network adapter buffer 22.

The acknowledgment sent to the device driver 14 by the network adapter 12 is typically in the form of an interrupt asserted by the adapter 12. The device driver 14 will recognize the interrupt and invoke an interrupt handling routine which recognizes the interrupt as an acknowledgment of the successful data transfer. In addition, the device driver 14 can pass the acknowledgment onto the application 10 as described above. Further, the device driver 14 can forward another transmit request to the network adapter 12.

Notwithstanding, there is a continued need in the art to improve the performance of data transmission and other operations.

### BRIEF DESCRIPTION OF THE DRAWINGS

Referring now to the drawings in which like reference numbers represent corresponding parts throughout:

FIG. 1 illustrates prior art buffer arrangement in a computer system;

FIGS. 2 and 3 illustrate prior art data transfer operations involving an application, a device driver and a network adapter;

FIG. 4 illustrates an embodiment of a computing environment in which aspects of the description provided herein are employed;

FIG. 5 illustrates a prior art packet architecture;

FIG. 6 illustrates one embodiment of operations to perform data transfer among an application, a device driver and a network adapter in accordance with one embodiment of the present description; and

FIG. 7 illustrates an architecture that may be used with the described embodiments.

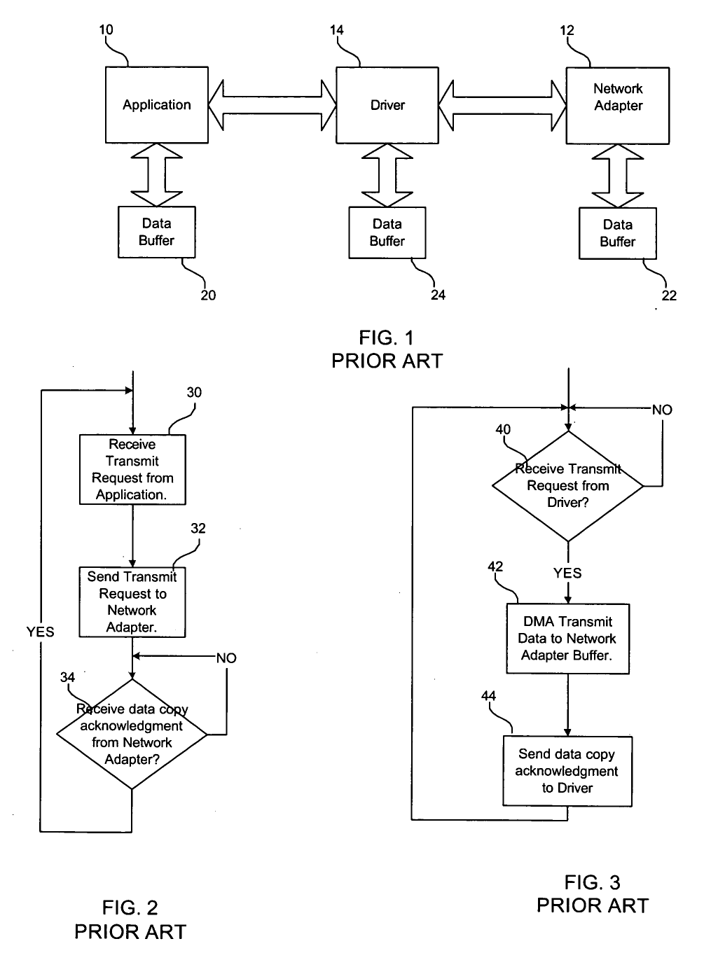

### DETAILED DESCRIPTION OF ILLUSTRATED EMBODIMENTS

In the following description, reference is made to the accompanying drawings which form a part hereof and which illustrate several embodiments of the present disclosure. It is understood that other embodiments may be utilized and structural and operational changes may be made without departing from the scope of the present description.

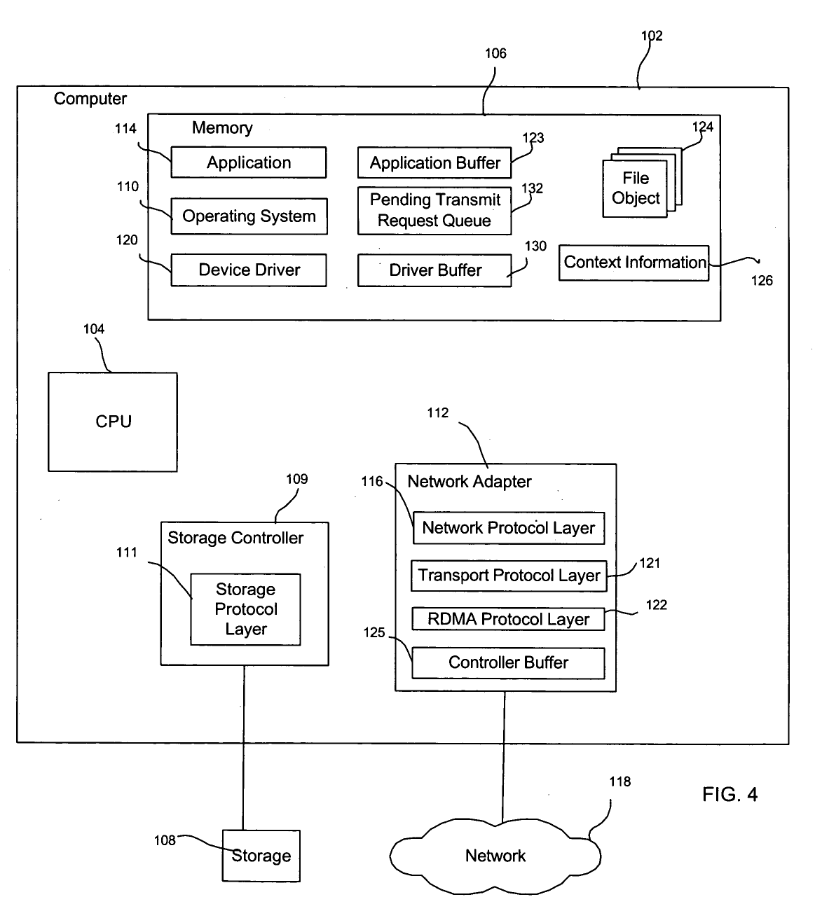

FIG. 4 illustrates an example of a computing environment in which aspects of described embodiments may be employed. A computer 102 includes one or more central processing units (CPU) 104 (only one is shown), a memory 106, non-volatile storage 108, a storage controller 109, an operating system 110, and a network adapter 112. An application 114 further executes in memory 106 and is capable of transmitting and receiving packets from a remote computer. The computer 102 may comprise any computing device known in the art, such as a mainframe, server, personal computer, workstation, laptop, handheld computer, telephony device, network appliance, virtualization device, storage controller, etc. Any CPU 104 and operating system 110 known in the art may be used. Programs and data in memory 106 may be swapped into storage 108 as part of memory management operations.

The storage controller 109 controls the reading of data from and the writing of data to the storage 108 in accordance with a storage protocol layer 111. The storage protocol of the layer 111 may be any of a number of known storage protocols including Redundant Array of Independent Disks (RAID), High Speed Serialized Advanced Technology Attachment (SATA), parallel Small Computer System Interface (SCSI), serial attached SCSI, etc. Data being written to or read from the storage 108 may be cached in accordance with known caching techniques. The storage controller may be integrated into the CPU chipset, which can include various controllers including a system controller, peripheral controller, memory controller, hub controller, I/O bus controller, etc.

The network adapter 112 includes a network protocol layer 116 to send and receive network packets to and from remote devices over a network 118. The network 118 may comprise a Local Area Network (LAN), the Internet, a Wide Area Network (WAN), Storage Area Network (SAN), etc. Embodiments may be configured to transmit data over a wireless network or connection, such as wireless LAN, Bluetooth, etc. In certain embodiments, the network adapter 112 and various protocol layers may implement the Ethernet protocol over unshielded twisted pair cable, token ring protocol, Fibre Channel protocol, Infiniband, etc., or any other network communication protocol known in the art. The network adapter may be integrated into the CPU chipset, which can include various controllers including a system controller, peripheral controller, memory controller, hub controller, I/O bus controller, etc.

A device driver 120 executes in memory 106 and includes network adapter 112 specific commands to communicate with a network controller of the network adapter 112 and interface between the operating system 110, applications 114 and the network adapter 112. As used herein, an application 114 can include a driver which is at a higher level than the device driver 120 for the network adapter 112, and can also include portions of the operating system 110. The network controller can implement the network protocol layer 116 and can control other protocol layers including a data link layer and a physical layer which includes hardware such as a data transceiver.

In certain embodiments, the network controller of the network adapter 112 includes a transport protocol layer 121 as well as the network protocol layer 116. For example, the network controller of the network adapter 112 can include a transport protocol controller such as a TOE, in which many transport layer operations can be performed within the network adapter 112 hardware or firmware, as opposed to the device driver 120 or other host software.

The transport protocol operations include obtaining transmit data placed in an application buffer residing in the system memory 106, temporarily storing the transmit data in a buffer such as a network controller buffer 125, packaging the transmit data in TCP/IP packets with checksum and other information and sending the packets. These sending operations are performed by an agent which may be embodied in a TOE, a network interface card or integrated circuit, a driver, TCP/IP stack, a host processor or a combination of these elements. The transport protocol operations also include receiving a TCP/IP packet from over the network and unpacking the TCP/IP packet to access the payload data. These receiving operations are performed by an agent which, again, may be embodied in a TOE, a driver, a host processor or a combination of these elements.

The network layer 116 handles network communication and provides received TCP/IP packets to the transport protocol layer 121. The transport protocol layer 121 interfaces with the device driver 120 or operating system 110 or an application 114, and performs additional transport protocol layer operations, such as processing the content of messages included in the packets received at the network adapter 112 that are wrapped in a transport layer, such as TCP and/or IP, the Internet Small Computer System Interface (iSCSI), Fibre Channel SCSI, parallel SCSI transport, or any transport layer protocol known in the art. The transport protocol layer 121 can unpack the payload from the received TCP/IP packet and transfer the data to the device driver 120, an application 114 or the operating system 110.

In certain embodiments, the network controller and network adapter 112 can further include an RDMA (Remote Direct Memory Access) protocol layer 122 as well as the transport protocol layer 121. For example, the network controller of the network adapter 112 can include a Remote Direct Memory Access (RDMA) enabled Network Interface Card (RNIC), in which RDMA layer operations are performed within the network adapter 112 hardware, as opposed to the device driver 120 or other host software. Details on the RDMA protocol are described in the technology specification “Architectural Specifications for RDMA over TCP/IP” Version 1.0 (October 2003).

Thus, for example, an application 114 transmitting messages over an RDMA connection can transmit the message through the device driver 120 and the RDMA protocol layer 122 of the network adapter 112. The data of the message can be sent to the transport protocol layer 121 to be packaged in a TCP/IP packet before transmitting it over the network 118 through the network protocol layer 116 and other protocol layers including the data link and physical protocol layers.

The memory 106 further includes file objects 124, which also may be referred to as socket objects, which include information on a connection to a remote computer over the network 118. The application 114 uses the information in the file object 124 to identify the connection. The application 114 uses the file object 124 to communicate with a remote system. The file object 124 may indicate the local port or socket that will be used to communicate with a remote system, a local network (IP) address of the computer 102 in which the application 114 executes, how much data has been sent and received by the application 114, and the remote port and network address, e.g., IP address, with which the application 114 communicates. Context information 126 comprises a data structure including information the device driver 120, operating system 110 or an application 114, maintains to manage requests sent to the network adapter 112 as described below.

In the illustrated embodiment, the CPU 104 programmed to operate by the software of memory 106 including one or more of the operating system 110, applications 114, and device drivers 120 provides a host which interacts with the network adapter 112. A host may be embodied in a variety of devices such as a host computer 102 or other devices. In the illustrated embodiment, a data send and receive agent includes the transport protocol layer 121 and the network protocol layer 116 of the network interface 112. However, the data send and receive agent may be embodied in a TOE, a network interface card or integrated circuit, a driver, TCP/IP stack, a host processor or a combination of these elements. The network controller may comprise hardware, software, firmware or any combination of these elements.

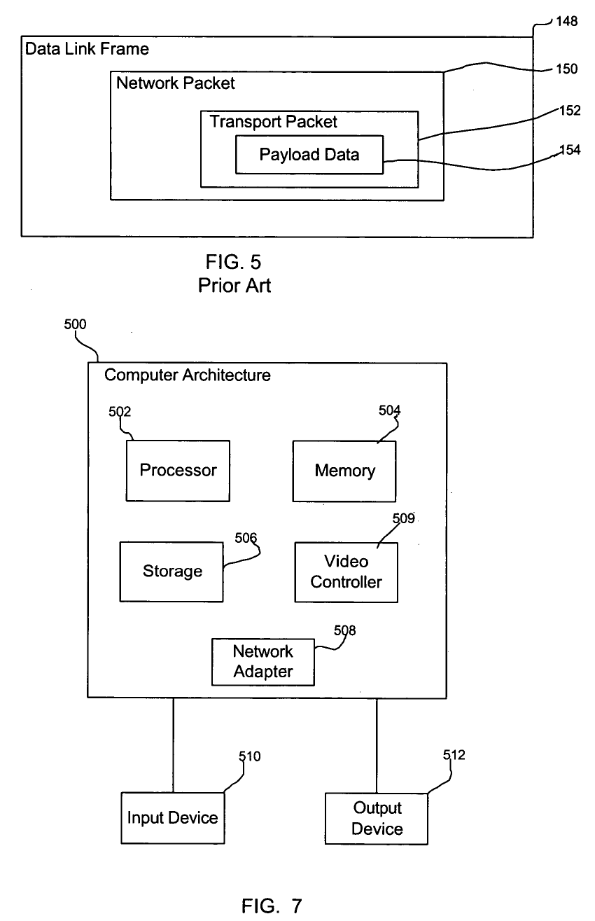

FIG. 5 illustrates a format of a network packet received at or transmitted by the network adapter 112. A data link frame 148 uses a format understood by the data link layer, such as 802.11 Ethernet. Details on this Ethernet protocol are described in “IEEE std. 802.11,” published 1999-2003. An Ethernet frame includes additional Ethernet components, such as a header and an error checking code (not shown). The data link frame 148 includes a network packet 150, such as an IP datagram. The network packet 150 has a format understood by the network protocol layer 116, such as such as the IP protocol. A transport packet 152 is included in the network packet 150. The transport packet 152 is capable of being processed by the transport protocol layer 121, such as the TCP. The packet may be processed by other layers in accordance with other protocols including Internet Small Computer System Interface protocol, Fibre Channel SCSI, parallel SCSI transport; etc. The transport packet 152 includes payload data 154 as well as other transport layer fields, such as a header and an error checking code. The payload data 152 includes the underlying content being transmitted, e.g., commands, status and/or data. The driver 120, operating system 110 or an application 114 may include a layer, such as a SCSI driver or layer, to process the content of the payload data 154 and access any status, commands and/or data therein.

In accordance with one aspect of the description provided herein, the interactions between the device driver 120 and an application 114 may be decoupled from the interactions between the device driver 120 and the network controller of the network adapter 112. As explained in greater detail below, transmit requests from an application 114 may be posted by the device driver 120 to the network controller of the network adapter 112 in a pipeline of transmit requests without waiting for an acknowledgment of the transfer of the accompanying transmit data to the network controller for each transmit request before sending the next transmit request to the network controller.

In another aspect, a device driver such as the device driver 120 monitors the available buffer space of a network controller buffer such as the network controller buffer 125, to ensure that the network controller has sufficient available buffer space before posting the next transmit request to the network controller. In this manner, the device driver 120 can continue to stream transmit data from one or more application buffers 123 into the network controller without waiting for a response from the network controller indicating the status of a particular transmit request. If the network controller buffer 125 does not have sufficient space available to accommodate the transmit data of the next transmit request, that transmit request may be queued in a pending transmit request queue 132. As a consequence, in some applications, latency can be reduced and throughput increased.

In accordance with yet another aspect, the device driver 120 can copy transmit data from an application buffer 123 to a driver buffer 130 if the size of the transmit data of a particular transmit request is below a programmable threshold. If so, the device driver 120 can notify the application 114 which provided the transmit request that the transmit operation is complete or at least that the transmit data has been successfully copied. As a consequence, the application buffer 123 can be released for other purposes.

The transmit data may be subsequently copied from the driver buffer 130 to the network controller buffer 125. Upon receiving notification of completion of the transfer of the transmit data, the driver buffer 130 can be released.

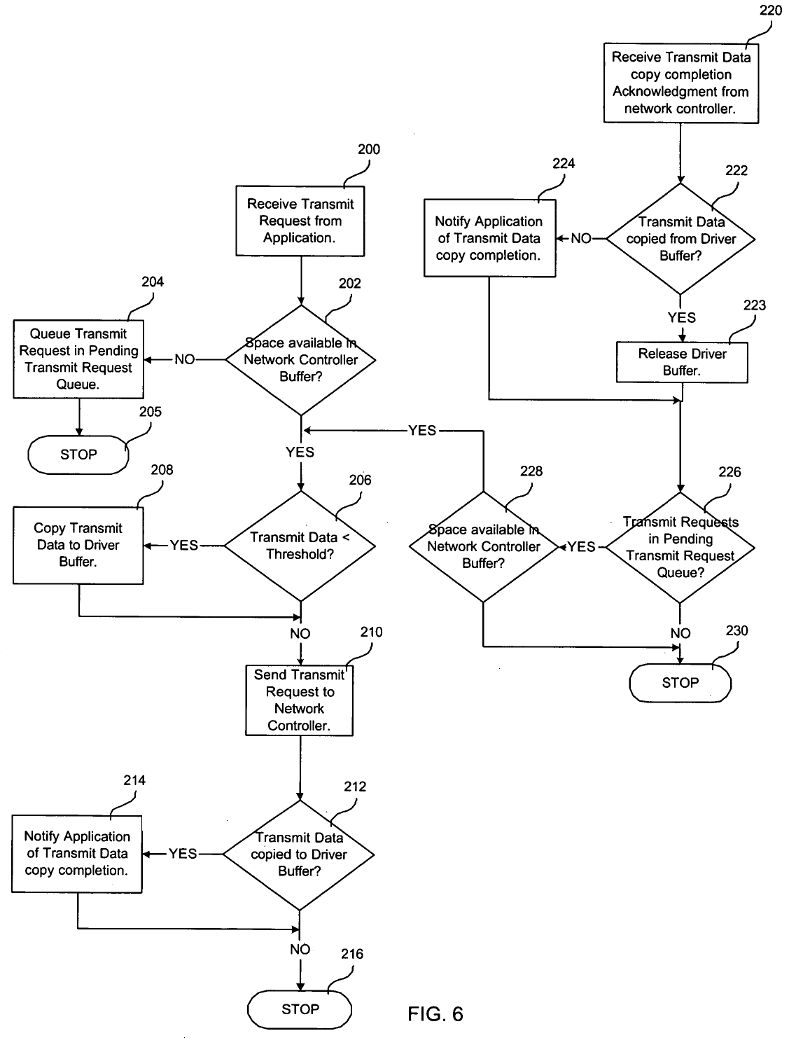

FIG. 6 shows one example of operations of a device driver such as the device driver 120 to manage data transmit operations between an application such as an application 114 and a network controller such as the controller of the network adapter 112. Upon receipt (block 200) of a transmit request from an application 114, a determination (block 202) is made as to whether there is sufficient space available in the network controller buffer 125 to accept the transmit data of the transmit request provided by the application 114. If not, the transmit request may be queued (block 204) in a pending transmit request queue 132 (FIG. 4) maintained by the device driver 120 in the system memory 106, to await (block 205) the next transmit request (block 200) from an application 114 or the receipt of a transmit data copy acknowledgment from the network controller as described below.

In accordance with another aspect, if it is determined (block 202) that there is sufficient space available in the network controller buffer 125 to accept the transmit data of the transmit request provided by the application 114, another determination (block 206) may be made as to whether the size of the transmit data of the transmit request is below a certain threshold. If so, the device driver 120 can copy (block 208) the transmit data to the driver buffer 130 before it is subsequently copied to the network controller buffer 125. Such an arrangement can improve throughput in some applications as described below.

The transmit request from the application 114 is posted or sent (block 210) to the network controller of the network adapter 112. The transmit request forwarded to the network controller can include information as to where the transmit data of the transmit request may be found. If the transmit data was copied (block 208) to the driver buffer 130, the network controller may be so informed. Otherwise, the network controller may be informed that transmit data may be found in the application buffer 123.

Accordingly, a determination (block 212) is made as to whether the transmit data was copied (block 208) to the driver buffer 130. If so, in addition to informing the network controller that the transmit data may be found in the device driver buffer 130, the application 114 which provided the transmit request may be notified (block 214) of the completion of the copying of the transmit data. As a result, the application 114 can release the application buffer 123 in the system memory 106 from which the transmit data was copied.

In response to the transmit request forwarded (block 210) by the device driver 120, the network controller of the network adapter 112 copies the transmit data of the transmit request to the network controller buffer 125. This transmit data is copied from the application buffer 123 unless the transmit data was previously copied (block 208) to the device driver buffer 130. Once the network controller has completed copying the transmit data from either the device driver buffer 130 or the application buffer 123, the network controller provides a transmit data copy completion acknowledgment to the device driver 120. The device driver 120 awaits (block 216) receipt of the transmit data copy completion acknowledgment from the network controller, or the next transmit request (block 200) from an application 114.

Upon receipt (block 220) of the transmit data copy completion acknowledgment from the network controller, a determination (block 222) is made as to whether the transmit data was copied (block 208) to the driver buffer 130. As previously mentioned, if the transmit data was copied (block 208) to the driver buffer 130, the application 114 which provided the transmit request may be notified (block 214) of the completion of the copying of the transmit data. Accordingly, upon receipt (block 220) of acknowledgment from the network controller, the driver buffer 130 from which the transmit data had been copied may be released (block 223) by the device driver 120.

On the other hand, if the transmit data was not copied from the driver buffer 130 such that the network controller copied the transmit data from the application buffer 123, the application 114 which provided the transmit request may be notified (block 224) of the completion of the copying of the transmit data upon receipt (block 220) by the driver 120 of the transmit data copy completion acknowledgment from the network controller. Thus, the application 114 may release the application buffer 123 from which the transmit data was copied to the network controller buffer 125.

A determination (block 226) is made as to whether there are any transmit requests queued in the pending transmit request queue 132. If so, a determination (block 228) is made as to whether there is sufficient space available in the network controller buffer 125 to accept the transmit data of the queued transmit request. The transmit data copy completion acknowledgment (block 220) from the network controller may include an indication of the amount of buffer space available in the network controller buffer 125. It is appreciated that other avenues may be provided for communicating the buffer space available information from the network controller to the device driver 120.

If it is determined (block 228) that there is sufficient space available in the network controller buffer 125 to accept the transmit data of the queued transmit request, the operations of blocks 206-216 may be repeated to forward the queued transmit request to the network controller and remove it from the queue. If there are no transmit requests queued in the pending transmit request queue 132, the device driver 120 awaits (block 230) receipt (block 220) of a transmit data copy completion acknowledgment from the network controller, or the next transmit request (block 200) from an application 114. Also, if there are transmit requests queued in the pending transmit request queue 132 but there is insufficient space available in the network controller buffer 125 to accept the transmit data of the queued transmit request, the device driver 120 awaits (block 230) receipt (block 220) of a transmit data copy completion acknowledgment from the network controller, or the next transmit request (block 200) from an application 114.

As previously mentioned, transmit data may be copied (block 208) to an intermediate buffer, such as the device driver buffer 130 if the size of the transmit data is below (block 206) a certain threshold. By copying the transmit data to the intermediate buffer 130 before the transmit data is copied to the network controller buffer 125, release of the application buffer 123 may be accelerated. In the illustrated embodiment, the threshold is selected to be relatively small, such as 4K bytes, for example, to reduce CPU utilization added by the intermediate buffer copy operations. It is appreciated that other thresholds may be selected, depending upon the particular application.

It is appreciated that upon the successful completion of the copying of the transmit data to the network controller buffer 125, the network adapter 112 may not be able to complete the transfer of the transmit data in the form of packets over the network 118 due to a variety of possible link problems. However, in the event of such a connection breakdown, the network controller of the network adapter 112 can notify the device driver 120 of the error condition. The device driver 120 can in turn inform the requesting application, typically in an asynchronous fashion, of the error condition in the connection. The application can then attempt to resend the transmit data until a successful transmission is achieved.

### Additional Embodiment Details

The described techniques for managing memory may be included as a method, apparatus or article of manufacture using standard programming and/or engineering techniques to produce software, firmware, hardware, or any combination thereof. The term “article of manufacture” as used herein refers to code or logic employed in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and nonvolatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments are employed may further be accessible through a transmission media or from a file server over a network. In such cases, the article of manufacture in which the code is embodied may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of the present descriptions, and that the article of manufacture may comprise any information bearing medium known in the art.

In the described embodiments, certain operations were described as being performed by the operating system 110, system host, device driver 120, or the network interface 112. In alterative embodiments, operations described as performed by one of these may be performed by one or more of the operating system 110, device driver 120, or the network interface 112. For example, memory operations described as being performed by the driver may be performed by the host.

In the described embodiments, a transport protocol layer 121 was embodied in the network adapter 112 hardware. In alternative embodiments, the transport protocol layer may be embodied in the device driver or host memory 106.

In certain embodiments, the device driver and network adapter embodiments may be included in a computer system including a storage controller, such as a SCSI, Integrated Drive Electronics (IDE), Redundant Array of Independent Disk, etc., controller, that manages access to a nonvolatile storage device, such as a magnetic disk drive, tape media, optical disk, etc. In alternative embodiments, the network adapter embodiments may be included in a system that does not include a storage controller, such as certain hubs and switches.

In certain embodiments, the device driver and network adapter embodiments may be employed in a computer system including a video controller to render information to display on a monitor coupled to the computer system including the device driver and network adapter, such as a computer system comprising a desktop, workstation, server, mainframe, laptop, handheld computer, etc. Alternatively, the network adapter and device driver embodiments may be employed in a computing device that does not include a video controller, such as a switch, router, etc.

In certain embodiments, the network adapter may be configured to transmit data across a cable connected to a port on the network adapter. Alternatively, the network adapter embodiments may be configured to transmit data over a wireless network or connection, such as wireless LAN, Bluetooth, etc.

The illustrated logic of FIG. 6 shows certain events occurring in a certain order. In alternative embodiments, certain operations may be performed in a different order, modified or removed. Moreover, operations may be added to the above described logic and still conform to the described embodiments. Further, operations described herein may occur sequentially or certain operations may be processed in parallel. Yet further, operations may be performed by a single processing unit or by distributed processing units.

FIG. 7 illustrates one embodiment of a computer architecture 500 of the network components, such as the hosts and storage devices shown in FIG. 4. The architecture 500 may include a processor 502 (e.g., a microprocessor), a memory 504 (e.g., a volatile memory device), and storage 506 (e.g., a nonvolatile storage, such as magnetic disk drives, optical disk drives, a tape drive, etc.). The storage 506 may comprise an internal storage device or an attached or network accessible storage. Programs in the storage 506 are loaded into the memory 504 and executed by the processor 502 in a manner known in the art. The architecture further includes a network adapter 508 to enable communication with a network, such as an Ethernet, a Fibre Channel Arbitrated Loop, etc. Further, the architecture may, in certain embodiments, include a video controller 509 to render information on a display monitor, where the video controller 509 may be embodied on a video card or integrated on integrated circuit components mounted on the motherboard. As discussed, certain of the network devices may have multiple network cards or controllers. An input device 510 is used to provide user input to the processor 502, and may include a keyboard, mouse, pen-stylus, microphone, touch sensitive display screen or any other activation or input mechanism known in the art. An output device 512 is capable of rendering information transmitted from the processor 502, or other component, such as a display monitor, printer, storage, etc.

The network adapter 508 may be embodied on a network card, such as a Peripheral Component Interconnect (PCI) card or some other I/O expansion card coupled to a motherboard, or on integrated circuit components mounted on the motherboard. The host interface may implement any of a number of protocols including PCI EXPRESS. Details on the PCI architecture are described in “PCI Local Bus, Rev. 2.3”, published by the PCI-SIG.

The foregoing description of various embodiments has been presented for the purposes of illustration and description. It is not intended to be exhaustive or to limit to the precise form disclosed. Many modifications and variations are possible in light of the above teaching. It is intended that the scope not be limited by this detailed description.

What is claimed is:

1. A method comprising:
sending a first transmit request to a network controller of a network adapter wherein the controller has a buffer and the first transmit request requests the transmission of first transmit data over a network;
sending a second transmit request to said network controller wherein the second transmit request requests the transmission of second transmit data over a network; and
receiving from the controller an acknowledgment of completion of the transfer of the first transmit data to the controller buffer after said second transmit request is sent to said controller.

2. The method of claim 1 further comprising:
receiving a transmit request from an application to transmit application transmit data over a network;
determining the space available in said controller buffer prior to sending a transmit request to said controller; and
queuing said application transmit request in a pending transmit request queue if insufficient space is available in said controller buffer to store said application transmit data.

3. The method of claim 2 further comprising:
in response to said controller acknowledgment, determining if said application transmit request is queued in said pending transmit request queue;
determining the space available in said controller buffer; and
sending said application transmit request from said pending transmit request queue if sufficient space is available in said controller buffer to store said application transmit data.

4. The method of claim 1 further comprising:
receiving a transmit request from an application to transmit over a network, application transmit data stored in an application buffer;
comparing the size of the application transmit data to a threshold; and
copying the application transmit data from said application buffer to a driver buffer if the size of said application transmit request data is below said threshold.

5. The method of claim 4 further comprising sending said application transmit request to said network controller; and notifying said application of completion of said application transmit data copying if said application transmit data was copied to a driver buffer.

6. The method of claim 5 further comprising receiving from the controller an acknowledgment of completion of copying of the application transmit data to the controller buffer, and in response to said completion acknowledgment, determining if said application transmit data was copied to a driver buffer and releasing said driver buffer if the application transmit data was transferred to the controller buffer from said driver buffer instead of the application buffer, and notifying said application of completion of the transfer of the application transmit data to the controller buffer if the application transmit data was transferred to the controller buffer from said application buffer instead of the driver buffer.

7. The method of claim 6 wherein the network controller has a transport protocol which is the Transmission Control Protocol (TCP).

8. The method of claim 1 wherein the network controller includes a Transmission Control Protocol offload engine (TOE).

9. The method of claim 1 wherein the sending and receiving operations are executed by a device driver for the network adapter.

10. An article comprising a storage medium, the storage medium comprising machine readable instructions stored thereon to:
send a first transmit request to a network controller of a network adapter wherein the controller has a buffer and the first transmit request requests the transmission of first transmit data over a network;
send a second transmit request to said network controller wherein the second transmit request requests the transmission of second transmit data over a network; and
receive from the controller an acknowledgment of completion of the transfer of the first transmit data to the controller buffer after said second transmit request is sent to said controller.

11. The article of claim 10 wherein the storage medium further comprises machine readable instructions stored thereon to:
receive a transmit request from an application to transmit application transmit data over a network;
determine the space available in said controller buffer prior to sending a transmit request to said controller; and
queue said application transmit request in a pending transmit request queue if insufficient space is available in said controller buffer to store said application transmit data.

12. The article of claim 11 wherein the storage medium further comprises machine readable instructions stored thereon to:
in response to said controller acknowledgment, determine if said application transmit request is queued in said pending transmit request queue;
determine the space available in said controller buffer; and
send said application transmit request from said pending transmit request queue if sufficient space is available in said controller buffer to store said application transmit data.

13. The article of claim 11 wherein the storage medium further comprises machine readable instructions stored thereon to:
receive a transmit request from an application to transmit over a network, application transmit data stored in an application buffer;
compare the size of the application transmit data to a threshold; and
copy the application transmit data from said application buffer to a driver buffer if the size of said application transmit request data is below said threshold.

14. The article of claim 13 wherein the storage medium further comprises machine readable instructions stored thereon to send said application transmit request to said network controller; and notify said application of completion of said application transmit data copying if said application transmit data was copied to a driver buffer.

15. The article of claim 14 wherein the storage medium further comprises machine readable instructions stored thereon to receive from the controller an acknowledgment of completion of copying of the application transmit data to the controller buffer, and in response to said completion acknowledgment, determine if said application transmit data was copied to a driver buffer and release said driver buffer if the application transmit data was transferred to the controller buffer from said driver buffer instead of the application buffer, and notify said application of completion of the transfer of the application transmit data to the controller buffer if the application transmit data was transferred to the controller buffer from said application buffer instead of the driver buffer.

16. The article of claim 15 wherein the network controller has a transport protocol which is the Transmission Control Protocol (TCP).

17. The article of claim 10 wherein the network controller includes a Transmission Control Protocol offload engine (TOE).

18. The article of claim 10 wherein the sending and receiving operations are executed by a device driver for the network adapter.

19. A system for use with a network, comprising:
at least one system memory which includes an operating system and an application;
a motherboard;
a processor mounted on the motherboard and coupled to the memory;
an expansion card coupled to said motherboard;
a network adapter mounted on said expansion card and having a buffer; and
a device driver executable by the processor in the system memory for said network adapter, said device driver having a buffer in said system memory, wherein the device driver is adapted to:
send a first transmit request to said network adapter wherein the first transmit request requests the transmission of first transmit data over said network;
send a second transmit request to said network adapter wherein the second transmit request requests the transmission of second transmit data over said network; and
receive from the network adapter an acknowledgment of completion of the transfer of the first transmit data to the network adapter buffer after said second transmit request is sent to said network adapter.

20. The system of claim 19 wherein the driver is further adapted to:
maintain in said system memory a queue of pending transmit requests to transmit application transmit data over a network;
receive a transmit request from an application to transmit application transmit data over a network;
determine the space available in said network adapter buffer prior to sending a transmit request to said network adapter; and
queue said application transmit request in a pending transmit request queue if insufficient space is available in said network adapter buffer to store said application transmit data.

21. The system of claim 20 wherein the driver is further adapted to:
in response to said network adapter acknowledgment, determine if said application transmit request is queued in said pending transmit request queue;
determine the space available in said network adapter buffer; and
send said application transmit request from said pending transmit request queue if sufficient space is available in said network adapter buffer to store said application transmit data.

22. The system of claim 20 wherein the application has a buffer in said system memory which contains application transmit data, and wherein the driver is further adapted to:
maintain a buffer in said memory;
receive a transmit request from the application to transmit over the network, said application transmit data stored in said application buffer;
compare the size of the application transmit data to a threshold; and
copy the application transmit data from said application buffer to said driver buffer if the size of said application transmit request data is below said threshold.

23. The system of claim 22 wherein the driver is further adapted to:
send said application transmit request to said network adapter; and notify said application of completion of said application transmit data copying if said application transmit data was copied to a driver buffer.

24. The system of claim 23 wherein the driver is further adapted to:
receive from the network adapter an acknowledgment of completion of copying of the application transmit data to the network adapter buffer, and in response to said completion acknowledgment, determine if said, application transmit data was copied to a driver buffer and release said driver buffer if the application transmit data was transferred to the network adapter buffer from said driver buffer instead of the application buffer, and notify said application of completion of the transfer of the application transmit data to the network adapter buffer if the application transmit data was transferred to the network adapter buffer from said application buffer instead of the driver buffer.

25. The system of claim 24 wherein the network adapter has a transport protocol which is the Transmission Control Protocol (TCP).

26. The system of claim 19 wherein the network adapter includes a Transmission Control Protocol offload engine (TOE).

27. A device driver for a network adapter for a network wherein the network adapter has a buffer, comprising
a memory and machine readable instructions stored in the memory to:
send a first transmit request to said network adapter wherein the first transmit request requests the transmission of first transmit data over said network;
send a second transmit request to said network adapter wherein the second transmit request requests the transmission of second transmit data over said network; and
receive from the network adapter an acknowledgment of completion of the transfer of the first transmit data to the network adapter buffer after said second transmit request is sent to said network adapter.

28. The device driver of claim 27 for use with an application wherein the driver is further adapted to:
maintain in said memory a queue of pending transmit requests to transmit application transmit data over said network;
receive a transmit request from an application to transmit application transmit data over a network;
determine the space available in said network adapter buffer prior to sending a transmit request to said network adapter; and
queue said application transmit request in a pending transmit request queue if insufficient space is available in said network adapter buffer to store said application transmit data.

29. The device driver of claim 28 wherein the driver is further adapted to:
in response to said network adapter acknowledgment, determine if said application transmit request is queued in said pending transmit request queue;
determine the space available in said network adapter buffer; and
send said application transmit request from said pending transmit request queue if sufficient space is available in said network adapter buffer to store said application transmit data.

30. The device driver of claim 28 wherein the application has a buffer in said memory which contains application transmit data, and wherein the driver is further adapted to:
maintain a buffer in said memory;
receive a transmit request from the application to transmit over the network, said application transmit data stored in said application buffer;
compare the size of the application transmit data to a threshold; and
copy the application transmit data from said application buffer to said driver buffer if the size of said application transmit request data is below said threshold.

31. The device driver of claim 30 wherein the driver is further adapted to:
send said application transmit request to said network adapter; and notify said application of completion of said application transmit data copying if said application transmit data was copied to said driver buffer.

32. The device driver of claim 31 wherein the driver is further adapted to:
receive from the network adapter an acknowledgment of completion of copying of the application transmit data to the network adapter buffer, and in response to said completion acknowledgment, determine if said application transmit data was copied to said driver buffer and release said driver buffer if the application transmit data was transferred to the network adapter buffer from said driver buffer instead of the application buffer, and notify said application of completion of the transfer of the application transmit data to the network adapter buffer if the application transmit data was transferred to the network adapter buffer from said application buffer instead of the driver buffer.

33. The device driver of claim 32 wherein the network adapter has a transport protocol which is the Transmission Control Protocol (TCP).

34. The device driver of claim 27 wherein the network adapter includes a Transmission Control Protocol offload engine (TOE).
